(19) United States
(12) Patent Application Publication
(10) Pub. No.: US 2017/0213288 A1
(43) Pub. Date: Jul. 27, 2017

(54) SYSTEMS AND METHODS FOR PERSONALIZED INVESTMENT ALLOCATION

(71) Applicant: INSTRUMENT CAPITAL LLC, Houston, TX (US)

(72) Inventors: Le ZHANG, Philadelphia, PA (US); Stephane COLAS, San Francisco, CA (US); Lance LEGEL, Stuart, FL (US)

(21) Appl. No.: 15/415,171

(22) Filed: Jan. 25, 2017

Related U.S. Application Data
(60) Provisional application No. 62/286,840, filed on Jan. 25, 2016.

(51) Int. Cl. G06Q 40/06; H04L 29/08

(52) U.S. Cl. CPC G06Q 40/06; H04L 67/02

(57) ABSTRACT

Generally disclosed here are a method, an information handling device, and a program product for managing a personalized investment system, including: obtaining investor information. The investor information may including demographic information, industry information, and historical financial information. Once the investor information is obtained, an embodiment may then analyze the demographic information, industry information, and historical financial information with respect to each other. A further embodiment may then create, based on the analysis, a personalized risk model. Using the personalized risk model, the method, information handling device, and/or program product may perform an action. Other aspects are described and claimed.

### CROSS-REFERENCE TO RELATED APPLICATIONS

This application claims the benefit of priority under 35 U.S.C. 119(e) to the filing date of U.S. Provisional Application 62/286,840 entitled, “SYSTEMS AND METHODS FOR PERSONALIZED INVESTMENT ALLOCATION” which was filed on Jan. 25, 2016, and which is incorporated herein by reference in its entirety.

### BACKGROUND

Investment strategies generally attempt to achieve investment portfolio diversification and to mitigate the risk of the investment portfolio while optimizing the rate of return. These strategies analyze volumes of market and industry data to predict investment performance. However, assumptions about investments and investors are at the core of the analytical engines used to generate these predictions. For example, Modern Portfolio Theory and the Capital Asset Pricing Model, two frameworks used for thinking about how to create a portfolio that maximizes returns while minimizing volatility, have many underlying assumptions that often do not hold true. One assumption held by the frameworks is that investors are currently holding diversified portfolios (or that the investors' other exposures and characteristics are “unobservable”). Another assumption held by the frameworks is that people are mean-variance optimizers. Under these models, when all the assumptions hold, assets are priced solely based on how they covary with the market portfolio (when the markets are efficient). In reality, the assumptions are not accurate because not all investors (for instance, startup founders and management teams, or even individual investors) are holding diversified portfolios. In addition, investing horizons vary widely from investor to investor; however, the Modern Portfolio Theory and the Capital Asset Pricing Model treat investors as having uniform investing horizons. Ultimately, the Modern Portfolio Theory and the Capital Asset Pricing Model (CAPM) do not work for individuals that fall outside of its assumptions.

Other common industry standards include multi-factor models under the Arbitrage Pricing Theory, the Fama-French three factor model, and Consumption CAPM. These models attempt to include economic and market factors besides the market risk premium to explain asset prices. It should be understood, that other models exist and may be used. For example, some models may be solely data mined, and not rely on statistical models at all.

In addition, conventional risk models were developed by financial professionals that predominantly serviced institutional clients and/or retirement funds. However, investment trends demonstrate a movement toward providing customized investment options that are shaped by the desire of retail investors to seek diversification and solid returns. Accordingly, the financial services industry would benefit from methods and systems capable of providing personalized investment services based on the personal characteristics and risk profiles of individual investors.

### BRIEF SUMMARY

In summary, one aspect provides a method of managing a personalized investment system. In an embodiment, the method may include obtaining, using a processor, investor information comprising demographic information, industry information, and historical financial information, analyzing, using the processor, the investor information, generating, based on the analysis of the investor information, a personalized risk model, and performing, using the processor, an action based on the personalized risk model. During the analyzing, the demographic information, industry information, and historical financial information may be analyzed with respect to each other.

Another aspect provides an information handling device for managing a personalized investment system. In an embodiment, the information handling device may include a processor and a memory device that stores instructions executable by the processor. The instructions may obtain, investor information comprising demographic information, industry information, and historical financial information, analyze the investor information, create, based on the analysis of the investor information, a personalized risk model, and perform, using the processor, an action based on the personalized risk model. During the analysis, the demographic information, industry information, and historical financial information are analyzed with respect to each other.

A further aspect provides a program product for managing a personalized investment system. In an embodiment, the program product may include a storage device having code stored therewith, the code being executable by the processor. The code may obtain investor information comprising demographic information, industry information, and historical financial information, analyze the investor information, create, based on the analysis of the investor information, a personalized risk model; and perform an action based on the personalized risk model. During the analysis, the demographic information, industry information, and historical financial information are analyzed with respect to each other;

### BRIEF DESCRIPTION OF THE DRAWINGS

The above and other objects of the present invention will become more readily apparent from the following detailed description taken in connection with the accompanying drawings.

FIG. 1 depicts an illustrative personalized investment system according to a first embodiment.

FIGS. 2A and 2B depict investor side optimization using an illustrative personalized investment system according to some embodiments.

FIG. 3 depicts an illustrative personalized investment system according to some embodiments.

FIGS. 4A and 4B disclose illustrative investor allocation models using conventional processes and the personalization investment system according to some embodiments.

FIG. 5 illustrates various embodiments of a computing device for implementing the various methods and processes described herein.

### DETAILED DESCRIPTION

The described technology generally relates to systems, methods, and non-transitory computer-readable media for determining investment allocations based on personal information associated with one or more individuals. In some embodiments, an individual may include an entity (for instance, an “institutional investor” and/or an employer). In some embodiments, an individual may be an individual investor (for instance, a “retail investor”) and/or an employee of an entity. In some embodiments, a personalized investment system (the “investment system”) may be configured to generate one or more personalized investment allocations and/or personalized investment structures. In general, a personalized investment allocation may include the investment of funds of an individual in one or more investment vehicles, such as a fund, a bond, an asset, a holding, or the like (i.e., purchasing a stock, investing in an exchange traded fund (ETF), or the like). A personalized investment structure may generally include an investment structure configured based on personal information associated with an investor. Non-limiting examples of investment structures include investment portfolios, investment funds (i.e., ETFs, mutual funds), or the like.

In some embodiments, the investment system may be configured to receive investor information associated with an investor. The investor information may generally include any information about the investor that may be used by the system to generate a personalized investment allocation and/or a personalized investment structure. Non-limiting examples of investor information may include demographic information, occupational information, and financial information. Demographic information may include personal characteristics of an investor, including, without limitation, the investor's name, age, address, gender, marital status, education, or the like. For example, in an embodiment, investor information related to education may be, but is not limited to, information about a school network, information relating to one or more degree types, and information relating to one or more majors.

Occupational information may include information related to the occupation of an investor, such as an employer, an employment sector or field (i.e., energy, finance, construction, or the like), a job title or description, a position (i.e., executive, professional, or the like), an equity status (i.e., whether investor has equity in employer), an employment status, a length of employment, a self-employment status, an entrepreneur status, or the like. Financial information may include information relating to the financial assets and/or investment goals of an investor, including, without limitation, the investor's salary, assets (i.e., savings accounts, investment accounts, stock holdings, real estate holdings, or the like), risk tolerance, retirement status, projected retirement age, available investment funds, or the like.

In some embodiments, the investor information may be gathered automatically using one or more of the computer systems discussed herein. Various third parties (e.g., banks, social media applications, mobile applications, etc.) may collect investor information. For example, LinkedIn may have investor information relating to education level, name, age, gender, work place history, etc. (LINKEDIN is a registered trademark of LinkedIn Corporation in the United States of America and other countries). Thus, some embodiments may utilize custom or generic Application Program Interfaces (API) to facilitate transfer of the investor information from one or more third party systems to the investment system. For example, in some embodiments, APIs may be used to gather information related to a social network, such as, for example, one or more contact names, one or more groups associated with specific contacts (e.g., family, friend. etc.)

In some embodiments, the third party systems may be data aggregation or technology service companies. For example, Google collects a large amount of data relating to their users via a user Google profile, which stores for example, web browsing habits, search history, type and number of electronic devices, books purchased, applications downloaded, calendar appointments made, contacts, location history, associated search history, purchase history, photos, phone calls, survey results, etc. (GOOGLE is a registered trademark of Google Inc. in the United States of America and other countries). Apple also has similar capabilities with regard to data aggregation regarding their users. (APPLE is a registered trademark of Apple Inc. in the United States of America and other countries). It should be understood that these are simply non-limiting examples, and that other organizations (e.g., technology corporations, banks, credit bureaus, etc.) and investor information may be utilized in one or more embodiments.

Thus, the various investor information discussed herein, may be gathered by the various third party systems and automatically collected by the investment system via a network connection (e.g., using API(s) to interface with remote systems). The automatic data collection allows the investment system to gather data and make determinations automatically without user intervention and thus results in dramatically improved investment guidance. In some embodiments, the investment system may also, as discussed herein, execute actions on behalf of the investor automatically (e.g., buying or selling particular investments based on gathered or updated data).

In some embodiments, the investment system may be configured to receive industry information associated with an industry (i.e., oil and gas, healthcare, energy, manufacturing, or the like). The industry information may generally include any information about an industry, field, sector, employer, or the like that may be used by the system to generate a personalized investment allocation and/or a personalized investment structure. Non-limiting examples of industry information may include labor statistics, salary information, industry phase and/or corporate lifecycle stage, historical information (i.e., growth, revenue size, market share, or the like), influences (i.e., industry relationships, conditions, or the like that may influence the industry), or the like.

Similar to the investor information, some embodiments may gather industry information automatically using one or more computer systems discussed herein. Various third party systems may already monitor and maintain extensive reports on one or more industries. For example, public Securities and Exchange Commission (SEC) filings and company reports may be accessed by the investment system via a network connection. Another class of third party systems that capture industry information may include private sector databases, for example those listed in the Warton Research Data Services (WRDS). In other embodiments, the investment system may scrape website data from various sources, such as stock trackers, company specific websites where profits are reported, and the like.

Thus, the various industry information discussed herein may be gathered by the various third party systems and/or the investment system itself via web scraping associated and automatically acquired by the industry information (e.g., via a network connection). The automatic data collection allows the investment system to gather data and make determinations automatically without user intervention and thus dramatically improves investment guidance. In some embodiments, the investment system may also, as discussed herein, execute actions on behalf of the investor automatically (e.g., buying or selling particular investments based on gathered or updated data).

In some embodiments, the investment system may be configured to receive historical finance information relating to historical data of financial markets, investment portfolios, investment strategies, or the like. The historical finance information may generally include any historical financial or market information that may be used by the system to generate a personalized investment allocation and/or a personalized investment structure. Non-limiting examples of historical financial information may include historical information for public stock indices, real estate holdings, markets, and/or indices, inflation/deflation, currency values, interest rates, traded funds (i.e., ETFs, mutual funds, or the like), stock values, government filings (i.e., company 10-K filings with the Securities and Exchange Commission (SEC)), or the like.

In some embodiments, the historical financial information may be gathered automatically using one or more computer systems, as discussed herein. Generally, a large quantity of financial data is freely available for publicly traded companies. This historical financial data may be gathered and maintained by the investment system, as discussed herein. Alternatively, the historical financial information may be acquired from one of the many third party entities that track the market and valuation of companies. For example, Thomson Reuters, Xignite, Bloomberg, and Compustat are a few non-limiting examples of companies that monitor and record financial data. (THOMSON REUTERS is a registered trademark of the Thomson Reuters Limited Corporation in the United States of America and other countries. XIGNITE is a registered trademark of Xignite, Inc. in the United States of America and other countries. BLOOMBERG is a registered trademark of Bloomberg Finance One L.P. in the United States of America and other countries. COMPUSTAT is a registered trademark of Standard & Poor's Financial Services LLC in the United States of America and other countries).

Thus, the various historical financial information discussed herein may be gathered by the various third party systems and/or the investment system and automatically analyzed by the investment system. The automatic data collection allows the investment system to gather data and make determinations without user intervention and thus results in dramatically improved investment guidance. In some embodiments, the investment system may also, as discussed herein, execute actions on behalf of the investor automatically (e.g., buying or selling particular investments based on gathered or updated data).

In some embodiments, the investment system may be configured to analyze the investor information, the industry information, and/or the historical financial information and to generate one or more risk models. For example, the investment system may be configured to generate a personalized model, such as a personalized risk model or a personalized investment model, for a specific investor based on their particular information. The system may use the personalized model to generate a personalized investment portfolio. For example, such a portfolio may include a personalized investment allocation and/or a personalized investment structure for the investor.

The investor information, industry information, and historical financial information (i.e., collectively “the information”) that is collected, as discussed herein, may be stored before, during, or after analyzing the information. In some embodiments, the information may be stored locally on the investment system or on a client device used by a user. Additionally or alternatively, the information may be stored on a remote server and accessed via the investment system or a client device for analysis. Various non-limiting examples of a server system are disclosed herein that may be used for storing and/or analyzing the information. The stored and/or analyzed information may be accessed by the investment system to provide investment guidance to the user and/or to determine an action to execute that alters a user's financial investment.

The investment system described according to some embodiments provides multiple technological advantages and technical effects on processes and techniques, including processes and techniques external to the investment system. For example, the investment fund may provide personalization to the investment process for individuals, which is lacking in conventional investment techniques and products (i.e., conventional investment software, algorithms, models, strategies, products, or the like). Personalization may allow an individual to invest based on their occupation, for instance, to hedge against risk within their industry.

For instance, a conventional investment model for individuals within a particular demographic and investment risk group may be to invest a first percentage in investment products with energy sector holdings and a second percentage in real estate investment products (i.e., a real estate ETF) based on current market conditions and predicted trends. A first investor may be employed in the energy sector, for example, as an executive in a major oil and gas company and may not own any property except for her primary residence. A second investor may be employed in the healthcare sector and may own multiple commercial rental properties.

The first investor may be “overexposed” to the energy sector because she is more vulnerable to fluctuations in the energy sector, and the oil and gas sector in particular, than the average investor. However, conventional investment techniques and products do not take such personalized information into account. Similarly, the second investor may be overexposed with respect to the real estate market because the second investor is more vulnerable to fluctuations in the real estate market, and the commercial rental property market in particular, than the average investor. If there is a downturn in the energy sector, the first investor may be negatively affected from both an employment perspective (i.e., employment status, position, salary, raises, bonuses, or the like) and an investment perspective (i.e., the value of her holdings may decrease). Similarly, if there is a downturn in the real estate sector, the second investor may be negatively affected by a loss of value of both his commercial real estate properties and his real estate investment product.

Another non-limiting example could be individuals like the autoworkers in Detroit. Many of them had investments in the auto industry, not only from mutual funds, but also from profit sharing programs run within individual auto companies. Thus, if an investor that was employed at a major automaker did not make an effort to continually diversify their investments they would be heavily leveraged into the auto market. This scenario is one that actually played out in hundreds if not thousands of households in America's rust belt.

Accordingly, the investment system may operate to adjust investment recommendations and/or selections to avoid individual investor overexposure, for example, based on occupation, geographic location, investment holdings, and/or the like. In addition, the investment system may operate to personalize an investment allocation and/or an investment structure based on personal information associated with the investor, such as their occupation. In some embodiments, the investment system may be configured to operate with an institutional investor (i.e., a company) to generate personalized investment allocations and/or personalized investment structures for company employees. For instance, such employee personalized investment allocations and/or personalized investment structures may be configured to provide exposure to alternative assets, conditions, or the like than those associated with the company. In some embodiments, the employee's personalized investment structure may include an investment fund (i.e., ETF) recommended for employees or included in an employee retirement savings plan (i.e., 401k, 403b, or the like).

Another technological advantage is that the investment system may use statistical information and techniques that are more advanced and dynamic than conventional systems. For example, the investment system may use historical and up-to-date information from the Bureau of Labor Statistics (i.e., salary information for over 600 occupations in nearly 50 industries), pricing information for various investment funds (i.e., pricing data for Vanguard ETFs), stock index performance information (i.e., Ken French Data Library), real estate price index information (i.e., S&P/Case-Shiller Home Price Indices), inflation information (i.e., U.S. Consumer Price Index), mortgage rate information, currency information, commodities information, or the like. The investment system may use analytical techniques on such information, mean variance optimizations for up-to-date mean variance optimal portfolios (e.g., using statistical libraries in python, R, Java, C++, etc.), and by comparing the allocation of non-personalized (i.e., “conventional”) investment allocations and investment portfolios with personalized investment allocation and/or personalized investment structures generated according to some embodiments. It should be understood by those skilled in the art, that the number and prices nature of optimizations may change. Thus, it should be understood that the embodiments described herein may use any known or future determined optimization method, and any known or future determined programming apparatus for executing this optimization method.

As discussed herein, in some embodiments, the information (e.g., statistical information) may be in electronic format and thus may be automatically acquired by the investment system via any available method (e.g., transfer of data via network connection). Additionally, in some embodiments, the information may be in a physical format (e.g., paper documents). In instances where the data is in physical format, secondary systems (e.g., scanners, image capture devices, human data entry, etc.) may be utilized by the investment system or a third party to convert the data into an electronic format.

The investment system may perform an action based on the analyzed results of the investor information, industry information, and financial information (e.g., creating a personalized risk model, as discussed herein). Based on this analysis, some embodiments may take a specific action associated with the investor account. For example, an embodiment may purchase or sell particular stocks in an investor account. By way of non-limiting example, the investment system may directly or through a third party trading company buy or sell stocks on the public exchange market. Similarly, based on the information, in a further embodiment, the investment system may alter the make-up of the investment portfolio (e.g., buy bonds and sell stocks based on the investor's age and/or planned retirement age).

As discussed herein, various determinations may be made based on the information (e.g., investor information, industry information, and historical financial information) and the analysis thereof. For example, an embodiment may determine that an investor (e.g., retail investor, institutional investor, etc.) is too heavily leveraged in a specific area (e.g., oil and gas, technology, power generation, etc.) based on the analyzed information. In response to this determination, a further embodiment may automatically reduce any holdings the investment portfolio may have that are closely associated with the industry or company that is over represented in the investment portfolio. By way of non-limiting example, a typical retail investor may be invested in a standard mutual fund, but that retail investor may be employed by a large corporation that is also a relatively large portion of their current mutual fund. Thus, if the retail investor lost his/her job as a result of the company failing, they would not only be without employment, but their retirement and/or nest egg that they had invested in the company would be lost as well.

Thus, some embodiments not only gather data (e.g., from a third party source), but also execute some real action, responsive to the information gathering and analysis. Therefore, this clearly represents an improvement in the technical field, and clearly a substantial and novel improvement in the current state of the art.

The methods and systems described according to some embodiments may reduce the resources, time, and cognitive effort required for retail investors and/or financial professionals (i.e., personal and/or institutional financial advisors) to access, quantify, assess and generate personalized investment portfolios, including personal investment allocations and personal investment structures. For instance, the system may be configured to transform investor information and/or industry information into objects, object values, and/or characteristics of objects displayed on a graphical user interface. In this manner, information may be transformed into graphical interface objects and/or characteristics thereof that may be used to allow retail investors and/or financial professionals to more efficiently, effectively, and accurately obtain personalized investment allocations and/or personalized investment structures than is possible using conventional techniques and processes.

The investment system may present novel software tools and user interfaces that solve technical problems relating to quantifying and/or assessing investment risk, investment opportunities, and/or investment overexposure, for instance, by evaluating investor information, industry information, and/or historical financial information. The novel software tools may also allow a retail investor, institutional investor, and/or financial professional to efficiently and accurately visualize an investor's risk profile and recommended investment strategy.

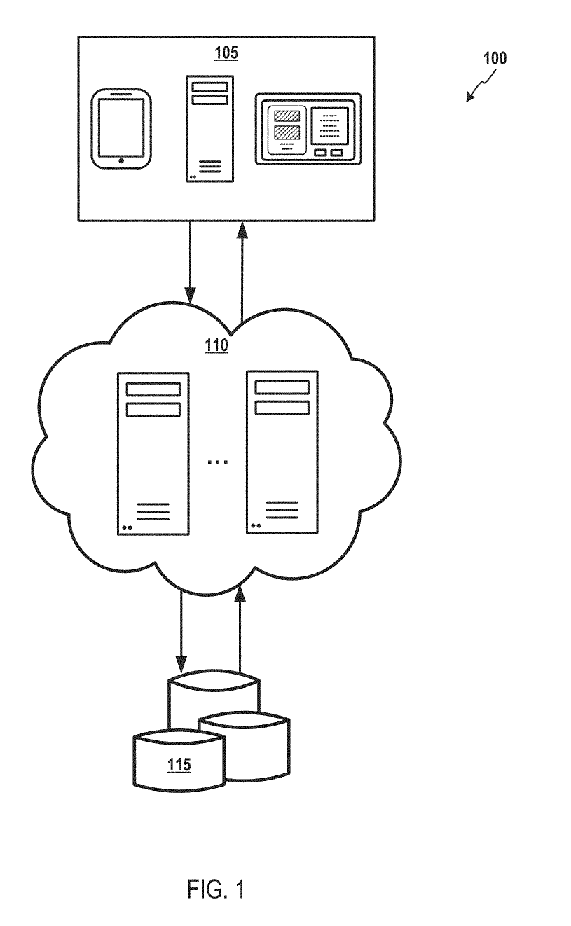

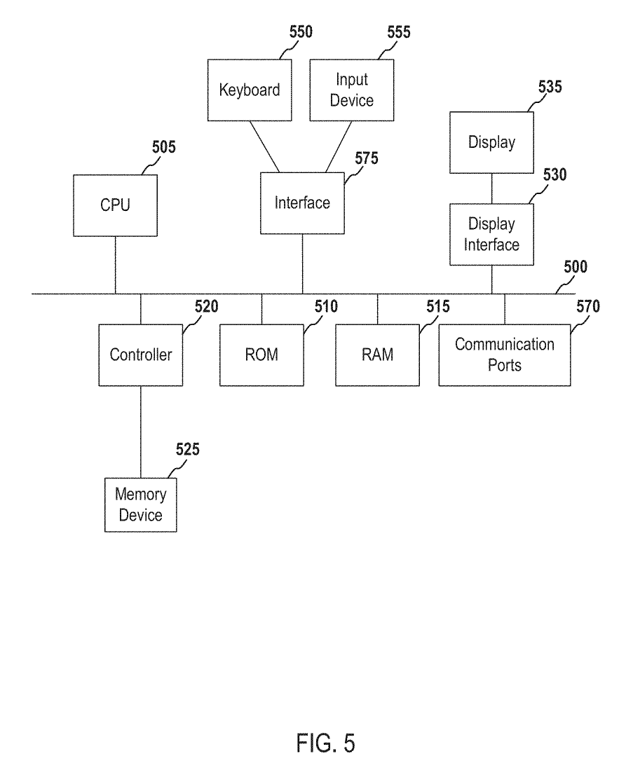

FIG. 1 depicts an illustrative investment system according to a first embodiment. As shown in FIG. 1, the system 100 may include one or more server logic devices 110, which may generally include a processor, a non-transitory memory or other storage device for housing programming instructions, data or information regarding one or more applications, and other hardware, including, for example, the central processing unit (CPU) 505, read only memory (ROM) 510, random access memory (RAM) 515, communication ports 570, controller 520, and/or memory device 525 depicted in FIG. 5 and described below in reference thereto.

In some embodiments, the programming instructions may include a personalized investment application (the “investment application”) configured to, among other things, analyze investor information, industry information, and/or historical financial information from various sources using personalized investment rules (“rules”) and generate graphical interfaces for presenting personalized investment models, strategies, investment allocations, and/or investment structures (“investment models”). The server logic devices 110 may be in operable communication with client logic devices 105, including, but not limited to, server computing devices, personal computers (PCs), kiosk computing devices, mobile computing devices, laptop computers, smartphones, personal digital assistants (PDAs), medical equipment, tablet computing devices, or the like.

In some embodiments, the investment application may be accessible through various platforms, such as a client application, web-based application, over the Internet, and/or a mobile application (for example, a “mobile app” or “app”). According to some embodiments, the investment application may be configured to operate on each client logic device 105 and/or to operate on a server computing device accessible to logic devices over a network, such as the Internet. All or some of the files, data, and/or processes used for generating investment models may be stored locally on each client logic device 105 and/or stored in a central location and accessible over a network.

In some embodiments, one or more data stores 115 may be accessible by the client logic devices 105 and/or server logic devices 110. The data stores 115 may include investor information, industry information, historical financial information, rules, and/or investment models, including third-party data sources thereof. In some embodiments, at least a portion of the data stores 115 may include information associated with an investment system, including, without limitation, government data sources (i.e., SEC, U.S. Department of Labor, U.S. Department of Finance, U.S. Census Bureau, Internal Revenue Service, or the like), investment fund data sources (i.e., Vanguard, PIMCO, or the like), and index information (i.e., Ken French Data Library, S&P/Case-Shiller Home Price Indices, or the like). Although the one or more data stores 115 are depicted as being separate from the logic devices 105, 110, embodiments are not so limited. All or some of the one or more data stores may be stored in one or more of the logic devices. In some embodiments, the investment application may be configured to use natural language processing to automatically extract information, including from the data stores 115 (i.e., understanding risks from corporate 10-K SEC filings).

As described in more detail below, the investment application may access information and/or processes stored in the data stores 115 to generate graphical user interface (GUI) objects (or “graphical objects’) for, among other things, presenting investment models to a user, such as a retail investor or financial professional, and/or effectuating investment allocations (i.e., stock purchases). A user may initiate the generation of a model from a client logic device 105, and the investment application may generate a graphical user interface object of a model for presentation on a display component of the client logic device.

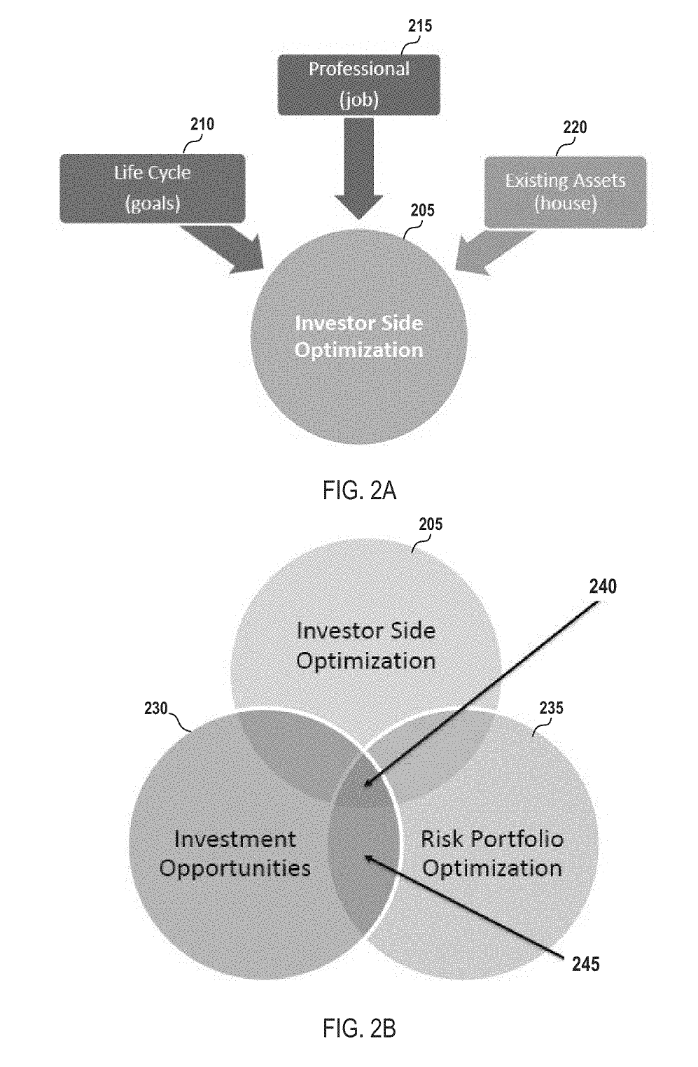

The investment system as configured according to some embodiments, may be used to implement investor side optimization in which investment strategies are optimized for an individual investor. FIGS. 2A and 2B depict investor side optimization using an illustrative investment system according to some embodiments. As shown in FIG. 2A, investor side optimization 205 may include accounting for an investor's entire life cycle 210, including their goals (i.e., children, occupation, employment income, housing, location of residence, lifestyle, or the like), constraints, and career life cycle (i.e., entry-level, management, executive, occupation transitions, or the like). In some embodiments, the investment system may be configured to develop differentiated career-optimized risk models, for example, for determining personalized investment allocations and/or personalized investment structures. The investor life cycle 210 may include estate planning, life transitions, or the like, which may have differentiated risk preferences. For example, when generating personalized investment allocations using a life cycle factor 210, the age and number of dependents should be taken into account to evaluate the preferred mix of investments and liquid assets. The investment system may be configured to dynamically evaluate a personalized investment portfolio, such as an investment allocation and/or an investment structure, based on the current and/or projected life cycle of an investor. In contrast, conventional investment techniques generally are limited to a snapshot in time of an investor, such as their current age, income, and projected retirement age.

Investor side optimization 205 may further include accounting for an investor's occupation (profession or job) 215. For example, the investor system may determine whether an investor may be overexposed due to the investor's occupation 215. In some embodiments, the investment system may calculate the covariance between the industry of an investor's occupation 215 and the market and adjust investment choices accordingly. An occupation 215 factor may be of primary importance for investors or employers in cyclical, emerging, and/or highly-fluctuating industries, such as commodities, technology, or emerging growth sectors. In some embodiments, occupation 215 and stage of company of employment of the investor may be used to adjust an asset allocation determination. For example, the investment system may analyze the credit rating, stock price, or other information relating to an investor's public employer. In addition, the investment system may take into account that unstable professions and employment at early-stage companies may include a high degree of risk, which may affect investment strategy. For example, if an investor employed in a high-risk occupation or position states that they have a risk level of 4 out of 5 (with 5 being the highest risk tolerance level), the investment system may reduce the risk level used to account for the risk encountered due to the investor's employment.

Investor side optimization 205 may include accounting for an investor's existing assets 220. For example, the investment system may be configured to adjust investment allocation based on an investor's existing assets 220, such as real estate, stocks, bonds, employee stock options, or the like. In some embodiments, the investment system may adjust investment allocation based on an investor's existing assets 220, including the overall value of the assets, the percentage of the investor's overall assets, and/or the risk level associated with the assets.

As shown in FIG. 2B, conventional investment techniques may only analyze investment opportunities 230 using a risk portfolio optimization (i.e., Modern Portfolio Theory) 235 to arrive at a risk portfolio 245. The conventional risk portfolio 245 involves passive fund management, for example, that emulates market portfolios using index funds across investment assets.

In contrast, the investment system may generate a personalized risk portfolio 240 by analyzing investment opportunities 230, a risk portfolio optimization (i.e., modern portfolio theory) 235, and investor side optimization 205. The personalized risk portfolio 240 involves active fund management that may be used to expand investor offerings. Such an active personalized risk portfolio 240 may not be subject to the shortcomings of typical passive investment strategies. For example, an active personalized risk portfolio 240 may be geographically diversified, have exposure to companies at different stages of the corporate life cycle, and may include exposure to assets typically only available to high-net worth investors.

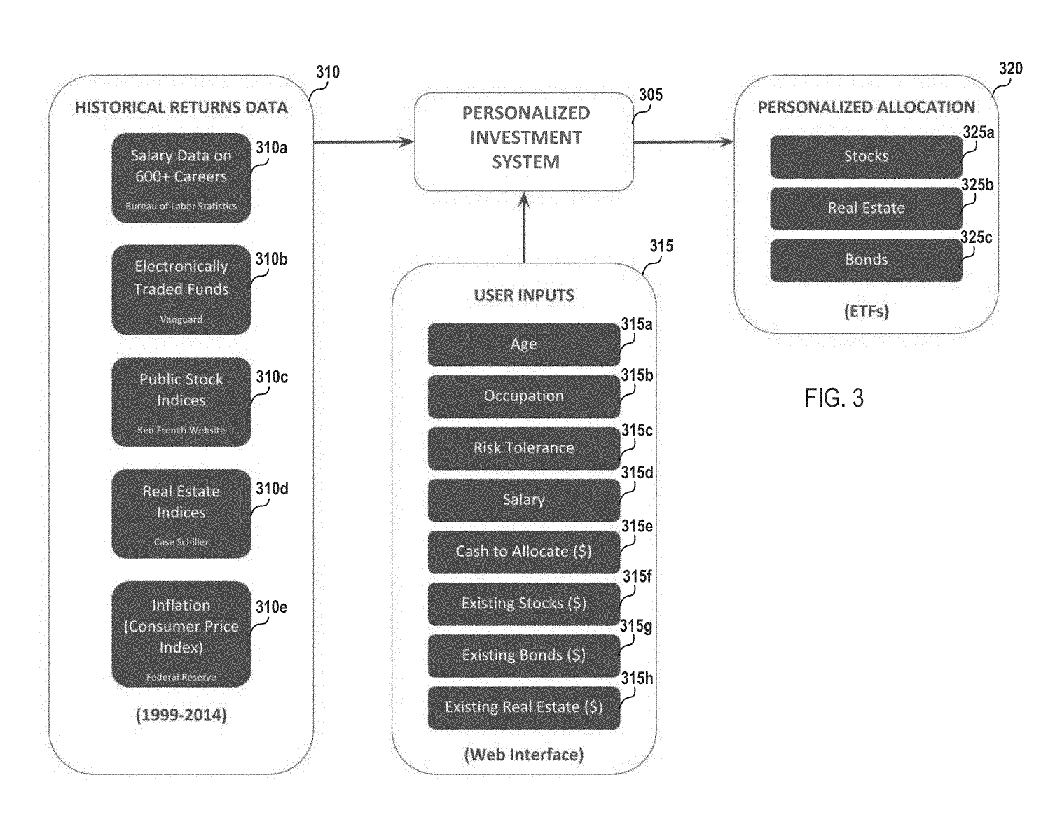

FIG. 3 depicts an illustrative personalized investment system according to some embodiments. As shown in FIG. 3, a personalized investment system 305 may be configured to receive historical returns data 310. Non-limiting examples of historical returns data 310 may include information relating to salary data 310a, electronically traded funds 310b, public stock indices 310c, real estate indices 310d, and inflation information 310e over a relevant time period (e.g., 1999-2014). The personalized investment system 305 may be configured to receive user input 315 relating to the investor (i.e., personalization information), for example, from a web-based interface. Non-limiting examples of user input 315 may include information relating to age 315a, occupation 315b, risk tolerance 315c, salary 315d, cash to allocate 315e, existing stocks 315f, existing bonds 315g, and existing real estate 315h.

In some embodiments, the personalized investment system 305 may analyze the historical returns data 310 and the user inputs 315 to generate a personalized allocation 320 for the user. For example, the personalized allocation 320 may specify investment values or ratios for various investment vehicles, such as stocks 325a, real estate 325b, and/or bonds 325c. In some embodiments, the personalized investment system 305 may store information relating to the personalized allocation 320 (“historical personalized allocation information”), including the particular allocations and the investment results (i.e., return information, changes to the allocation, risk outcomes, or the like). In some embodiments, the personalized investment system 305 may be configured to analyze the historical personalized allocation information to adjust the processes, algorithms, or the like for generating personalized allocations 320 based on actual, historical outcomes. In addition, the investment system 305 may be configured to provide the historical personalized allocation information to third parties, for example, for third parties to use this information as part of their risk assessment and trading models.

In other embodiments, the personalized investment system 305 may have a machine learning ability. The machine learning ability may gather and record various historical information obtained by the investment system and apply it to further determinations. By way of non-limiting example, an embodiment may present a user with multiple options for modifying their investment strategy. The investment system may then record the user's preferences with regard to the offered strategies and, over time, using machine learning, the investment system may be able to modify and/or adjust the recommendations offered to the user to better tailor the suggestions or changes to the individual user.

In a further non-limiting example embodiment, the investment system may utilize machine learning to improve the suggestions or modifications made to a user's investment portfolio. For example an embodiment may monitor a large number of investment portfolios that have been modified based on one or more previous suggestions and then determine which of the portfolios achieved higher than normal performance. The portfolios may then be grouped based on similarities in investment strategy determined by the investment system. These groupings may then be analyzed to determine what characteristics, if any, appear to reliably out preform others.

Other embodiments may utilize historical data related to career progression to enhance machine learning capabilities. For example, the investment system may be able to determine a normal or expected progression of an individual in a specific field (e.g., salary, market exposure, etc.). As discussed herein, a large amount of information is gathered. analyzed, and updated regularly, thus, an embodiment may easily track a user's career through their lifetime. Acquiring this data for a large amount of users, may allow an embodiment to modify portfolio suggestions or changes based on the expected career path of a specific individual.

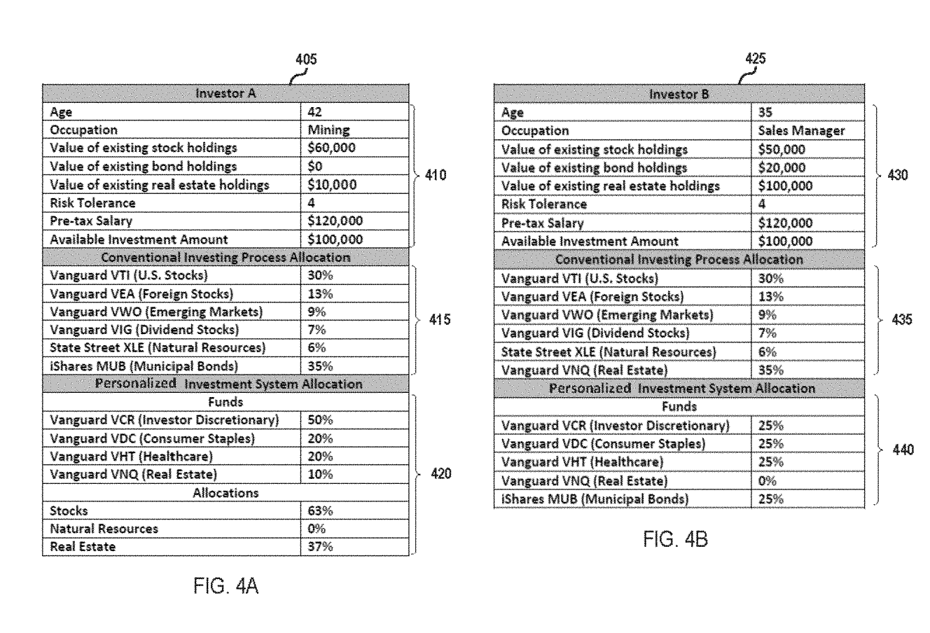

FIGS. 4A and 4B disclose illustrative investor allocation models using conventional processes and the personalization investment system according to some embodiments. As shown in FIG. 4A, Investor A 405 may be associated with investor information 410. A conventional investment process may not receive and/or use all of the investor information 410, such as occupation information. The conventional investment process may provide a conventional investment allocation 415, for example, that includes various investment funds and bonds. However, the conventional investment allocation 415 may leave Investor A 405 overexposed to natural resources because Investor A is employed in the mining industry. Accordingly, the personalized investment system may generate a personalized investment allocation 420 configured to account for the occupation of Investor A 405. For example, the personalized investment allocation 420 for Investor A 405 may not include any investments involving or substantially involving natural resources.

As shown in FIG. 4B, Investor B 425 may be associated with investor information 430. A conventional investment process may not receive and/or use all of the investor information 430, such as occupation and/or existing holdings information. The conventional investment process may provide a conventional investment allocation 435, for example, that includes various investment funds. The conventional investment allocation 435 may leave Investor B 425 overexposed to real estate because Investor B has significant existing real estate holdings. Accordingly, the personalized investment system may generate a personalized investment allocation 440 configured to account for the existing real estate holdings of Investor B 425. For example, the personalized investment allocation 440 for Investor B 425 may not include certain real estate funds.

FIG. 5 depicts a block diagram of exemplary internal hardware that may be used to contain or implement the various computer processes and systems as discussed above. A bus 500 serves as the main information highway interconnecting the other illustrated components of the hardware. CPU 505 is the central processing unit of the system, performing calculations and logic operations required to execute a program. CPU 505 is an exemplary processing device, computing device or processor as such terms are used within this disclosure. Read only memory (ROM) 530 and random access memory (RAM) 535 constitute exemplary memory devices.

A controller 520 interfaces with one or more optional memory devices 525 to the system bus 500. These memory devices 525 may include, for example, an external or internal DVD drive, a CD ROM drive, a hard drive, flash memory, a USB drive or the like. As indicated previously, these various drives and controllers are optional devices. Additionally, the memory devices 525 may be configured to include individual files for storing any software modules or instructions, auxiliary data, common files for storing groups of results or auxiliary, or one or more databases for storing the result information, auxiliary data, and related information as discussed above.

Program instructions, software or interactive modules for performing any of the functional steps associated with methods and processes described according to some embodiments may be stored in the ROM 530 and/or the RAM 535. Optionally, the program instructions may be stored on a tangible computer-readable medium such as a compact disk, a digital disk, flash memory, a memory card, a USB drive, an optical disc storage medium, such as a Blu-ray™ disc, and/or other recording medium.

An optional display interface 530 may permit information from the bus 500 to be displayed on the display 535 in audio, visual, graphic or alphanumeric format. Communication with external devices may occur using various communication ports 540. An exemplary communication port 540 may be attached to a communications network, such as the Internet or a local area network.

The hardware may also include an interface 545 which allows for receipt of data from input devices such as a keyboard 550 or other input device 555 such as a mouse, a joystick, a touch screen, a remote control, a pointing device, a video input device and/or an audio input device.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

What is claimed is:

1. A method of managing a personalized investment system comprising:
obtaining, using a processor, investor information comprising demographic information, industry information, and historical financial information;
analyzing, using the processor, the investor information, wherein the demographic information, industry information, and historical financial information are analyzed with respect to each other;
generating, based on the analysis of the investor information, a personalized risk model; and
performing, using the processor, an action based on the personalized risk model.

2. The method of claim 1, wherein the demographic information comprises at least one of a name, an age, an address, a gender, a marital status, and an education level.

3. The method of claim 1, wherein the industry information comprises at least one of an employer, an employment sector, an employment field, a job title, a position, an equity status, an employment status, a length of employment, a self-employment status, an entrepreneur status, and a work place history.

4. The method of claim 1, wherein the historical financial information comprises at least one of a salary, a financial asset owned, a savings account owned, an investment account owned, a stock holding, a credit rating, a credit history, a real estate holding, a real estate holding value, and a real estate holding location.

5. The method of claim 1, wherein obtaining investor information comprises receiving the investor information from a third party entity.

6. The method of claim 5, wherein the third party entity comprises at least one of a bank, a social media company, a mobile application company, a credit bureau, an online data aggregation company, and an technology service company.

7. The method of claim 6, wherein the third party entity provides investor information associated with at least one of a name, an age, an address, a gender, a marital status, an education level, an employer, an employment sector, an employment field, a job title, a position, an equity status, an employment status, a length of employment, a self-employment status, an entrepreneur status, a work place history salary, a financial asset owned, a savings account owned, an investment account owned, a stock holding, a real estate holding, one or more browsing habits, an internet search history, a type and number of electronic devices, a historical online purchase, a historical application purchase, a calendar appointment made, a contact, a phone call history, and a survey result.

8. The method of claim 1, wherein obtaining investor information comprises web scraping one or more websites associated with the investor information.

9. The method of claim 1, wherein performing an action based on the personalized risk model comprises displaying, on a display device, an investment strategy.

10. The method of claim 1, wherein performing an action based on the personalized risk model comprises at least one of buying one or more assets for incorporation into an investment portfolio and selling one or more assets from the investment portfolio.

11. An information handling device for managing a personalized investment system comprising:
a processor;
a memory device that stores instructions executable by the processor to:
obtain investor information comprising demographic information, industry information, and historical financial information;
analyze the investor information, wherein the demographic information, industry information, and historical financial information are analyzed with respect to each other;
generate, based on the analysis of the investor information, a personalized risk model; and
perform an action based on the personalized risk model.

12. The information handling device of claim 11, wherein the demographic information comprises at least one of a name, an age, an address, a gender, a marital status, and an education level.

13. The information handling device of claim 11, wherein the industry information comprises at least one of an employer, an employment sector, an employment field, a job title, a position, an equity status, an employment status, a length of employment, a self-employment status, an entrepreneur status, and a work place history.

14. The information handling device of claim 11, wherein the historical financial information comprises at least one of a salary, a financial asset owned, a savings account owned, an investment account owned, a stock holding, and a real estate holding.

15. The information handling device of claim 11, wherein obtaining investor information comprises receiving the investor information from a third party entity.

16. The information handling device of claim 15, wherein the third party entity comprises at least one of a bank, a social media company, a mobile application company, a credit bureau, and an online data aggregation company.

17. The information handling device of claim 11, wherein obtaining investor information comprises web scraping one or more websites associated with the investor information.

18. The information handling device of claim 11, wherein performing an action based on the personalized risk model comprises displaying, on a display device, an investment strategy.

19. The information handling device of claim 11, wherein performing an action based on the personalized risk model comprises at least one of buying one or more assets for incorporation into an investment portfolio and selling one or more assets from the investment portfolio.

20. A program product, comprising:
a storage device having code stored therewith, the code being executable by a processor and comprising:
code that obtains investor information comprising demographic information, industry information, and historical financial information;
code that analyzes the investor information, wherein the demographic information, industry information, and historical financial information are analyzed with respect to each other;
code that generates, based on the analysis of the investor information, a personalized risk model; and
code that performs an action based on the personalized risk model.
